(19) United States
(12) Patent Application Publication
(10) Pub. No.: US 2007/0109787 A1
(43) Pub. Date: May 17, 2007

(54) Light emitting heat sink fan

(76) Inventor: Chin-Ping Wu, Dongguan City (CN)

Correspondence Address: RABIN & BERDO, P.C., Suite 500, 1101 14th Street, N.W., Washington, DC, 20005, US

(21) Appl. No.: 11/271,964

(22) Filed: Nov. 14, 2005

(51) Int. Cl. F21V 29/00

(52) U.S. Cl. 362/294

(57) ABSTRACT

A light-emitting heat sink fan comprised of a stand, blades, and LED lamp adapted to a computer or power supply; one or multiple LED lamp being incorporated to blade of fan; a flaring IC to control flaring status of the fan; and a control PCB circuit controlling all the flaring patterns of the LED lamp; a power generation disposed between the blade and the stand supping power to the LED lamp without relying upon additional source and limiting the materials of the bland and the stand to emit fantastic and sparkling visual effects of lighting.

### BACKGROUND OF THE INVENTION

(a) Field of the Invention

The present invention is related to light emitting heat sink fan, and more particularly, to one that has LED directly mounted on the blade of the fan adapted to a computer or a power supply to give the fan ever-changing lighting visual effects subject to control by a flaring IC.

(b) Description of the Prior Art

A ventilating fan adapted to computer or power supplier is generally comprised of a stand and multiple blades. The blades rotate to accelerate airflow to achieve heat reduction purpose so to prevent mechanism in the computer or power supply from being burnt out due to excessively higher temperature.

The style of the conventional heat sink fan is dull. To give the fan visual effects, LED lamp is mounted on the fan to create circling light when the fan is operating. Most of the heat sink fans generally available in the market have mounted multiple, typically three or four LED lamps on the mounting frame of the fan to create irregular lighting patterns for achieving visual effects. However, the mounting frame of the fan and the blades must be made of transparent materials to subject the structure of the heat sink fan to significant constrains, higher material costs, and poor light emitting results.

### SUMMARY OF THE INVENTION

The primary purpose of the present invention is to provide a light emitting heat sink fan to overcome those problems found with the prior art by applying the working principle of a power generator and directly mounting LED lamps on the blades of the fan to create ever-changing light flaring effects in conjunction with a separately provided flaring IC.

To achieve the purpose, the present invention is essentially comprised of a stand and multiple blades. Multiple LED lamps are mounted on those blades, and a power generation unit is disposed at where those blades are incorporated with the stand. The power generation unit, a control PCB circuit, and LED lamps define a light emitting loop. A rectifying circuit and filtering circuit are provided on the control PCB circuit. One or multiple LED lamp may be provided and a flaring IC is provided to the control PCB circuit or LED lamp to control the flaring status of the LED lamp for creating visual effects of fantastic and sparkling light flaring.

### BRIEF DESCRIPTION OF THE DRAWINGS

FIG. 1 is a schematic view showing a general construction of a preferred embodiment of the present invention.

FIG. 2 is a circuit drawing of the preferred embodiment of the present invention.

### DETAILED DESCRIPTION OF THE PREFERRED EMBODIMENTS

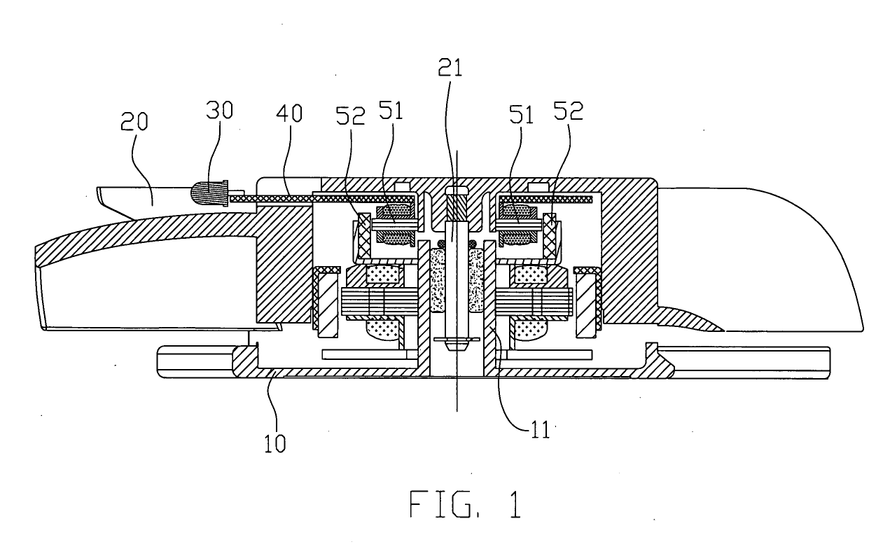

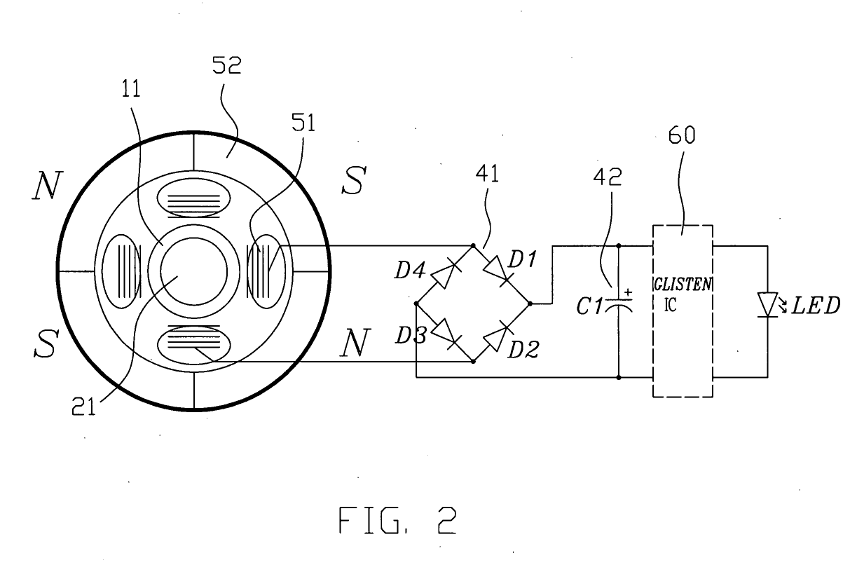

Referring to FIGS. 1 and 2 respectively for a construction and a circuit drawing of a preferred embodiment of the present invention, the heat sink fan is essentially comprised of a stand (10) and a blade (20). A spindle holder (11) protruding upright is disposed at the center of the stand (10) to receive insertion by a spindle (21) built in the blade (20) to rotate the fan. Coil and magnet are installed between the blade (20) and the stand (10). Once the coil is conducted, the fan starts to rotate to reduce the heat by facilitating air circulation to constitute a basic function configuration for the heat sink fan.

Wherein, the blade (20) is incorporated with one or multiple LED lamp (30) and a flaring IC (60) is further incorporated to the LED lamp (30) to control the LED lamp (30) in giving regular flaring.

A power generation unit disposed at where the blade (20) is incorporated to the stand (10) constitutes a light-emitting loop with a control PCB circuit (40) and the LED lamp (30). The power generation unit is comprised of a ferrite core (51) wrapped with enamel-insulated wire and an excitement of four-pole magnetic frame (52). The ferrite core (51) is fixed into the blade (20) and the magnetic frame (52) is installed at the spindle holder (11) of the stand (10). The ferrite core (51) wrapped with enamel-insulated wire rotates synchronously with the blade (20) for the enamel-insulated wire to create motion of a cutting magnetic line of force within the magnetic frame (52) thus to generate alternating current. The resultant alternating current is then converted into direct current through a rectifying circuit (41) and a filtering circuit (42) provided on the control PCB circuit (40) to supply power consumed by the flaring IC (60) and the LED lamp (30).

In the preferred embodiment as illustrated in FIG. 2, the rectifying circuit (41) on the control PCB circuit (40) is related to a bridge type comprised of four diodes D1, D2, D3, and D4 in the preferred embodiment and the filtering circuit (42) is related to a capacitor filtering circuit comprised of a capacitor C1. The flaring IC (6) for the LED lamp (30) is connected to the output end of the filtering circuit (42) so to control the LED lamp (30); or alternatively, the flaring IC (60) is built in the LED lamp (30). While the blade (20) is operating, corona regularly appears through the flaring of the LED lamp (30) to make the heat sink fan more attractive and better serving decorative purpose thanks to significant light emitting effects.

The design of taking advantage of the rotation by the blade (20) to generate power by the power generation unit disposed between the blade (20) and the stand (10) not only fortify the structure of the fan but also allows easy assembly. While the prior art relies upon power supply from a host of the computer; the present invention is self-sufficient since AC produced by the power generation unit after having been converted into DC through the rectifying circuit (41) and the filtering circuit (42) can be directly supplied to the LED lamp (30).

Furthermore, the LED lamp (30) is directly mounted on the blade (20) to provide fantastic and sparkling visual effects. Therefore, the blade (20) and the stand (10) are not necessarily made of see-through material for cost production to facilitate development of product. The entire unit of the light-emitting heat sink fan is standing alone without affecting the host and its peripheral to allow easier assembly while maintaining simple and attractive appearance.

The present invention provides the following advantages:

1. Wider range of application. With the LED lamp to be directly mounted on the blade, both of the blade and the stand are not constrained by transparent materials.

2. The power generation unit comprised of ferrite core wrapped with enamel-insulated wire and excitement four-pole magnetic frame is built in the blade to avoid visible conductor to maintain simplicity and attraction of the appearance.

3. One or multiple LED lamp may be provided and a flaring IC may be incorporated to the control PCB circuit to further add decoration purpose by creating dazzling corona.

However, it is to be noted that the preferred embodiments disclosed in the specification and the accompanying drawings are not limiting the present invention; and that any construction, installation, or characteristics that provides equivalent effects should fall within the scope of the purposes and claims of the present invention.

1. A light-emitting heat sink fan is essentially comprised of a stand and a blade; a spindle holder being disposed at the center of the stand; the spindle of the blade being inserted to the spindle holder; coil and magnet being disposed between the blade and the stand; the blade rotating when the coil is conducted to reduce heat; an LED lamp being incorporated to the blade; a power generation unit being provided at where the blade is incorporated to the stand; a light-emitting loop being defined by the power generation unit, a control PCB circuit and the LED lamp; and the control PCB circuit being disposed with a rectifying circuit and a filtering circuit.

2. The light-emitting heat sink fan of claim 1, wherein the power generation unit disposed at where the blade is incorporated to the stand is comprised of a ferrite core wrapped with enamel-insulated wire and an excitement 4-pole magnetic frame; the ferrite core being fixed inside the blade; and the magnetic frame being mounted on the spindle holder of the stand.

3. The light-emitting heat sink fan of claim 1, wherein one or multiple LED lamp is incorporated on the blade.

4. The light-emitting heat sink fan of claim 1, wherein the LED lamp incorporated to the blade emits light regularly through a flaring IC disposed on the control PCB circuit.

5. The light-emitting heat sink fan of claim 1, wherein the LED incorporated to the blade emits light regularly through the flaring IC directly built in the LED lamp.
